(19) United States
(12) Patent Application Publication
(10) Pub. No.: US 2011/0095897 A1
(43) Pub. Date: Apr. 28, 2011

(54) ENERGY USAGE INDEX

(75) Inventor: Praveen Kumar SUTRAVE, Sewickley, PA (US)

(73) Assignee: EATON CORPORATION, Cleveland, OH (US)

(21) Appl. No.: 12/605,677

(22) Filed: Oct. 26, 2009

(51) Int. Cl. G08B 21/00

(52) U.S. Cl. 340/635

(57) ABSTRACT

An energy usage index provides energy intensity monitoring and managing capability. This capability is accomplished by monitoring an energy usage of a facility region and calculating an energy intensity based, at least in part, on the energy usage of the facility region and an area of the facility region. The energy intensity of the facility region is displayed and an alert is generated if the energy intensity meets a threshold level.

### BACKGROUND

Creating energy efficient homes, vehicles, and buildings has become increasingly important in an environmentally conscious society. Energy efficiency refers to products or systems using less energy to do the same or better function than conventional products or systems. Therefore, energy efficiency results in reduced energy consumption, lower energy costs, and helps protect the environment by reducing the demand for electricity.

Energy efficiency is a key component of “green building.” Green building is a concept focusing on efficient uses of resources while reducing building impact on human health and the environment. The United States Green Building Council has implemented the Leadership in Energy and Environmental Design (LEED) certification and rating system for green buildings. LEED provides a concise framework for identifying and implementing practical green building design, construction, operations, and maintenance solutions. To achieve LEED certification, specific energy consumption standards are required. Investing in energy efficient building has the potential to reduce the nation's energy consumption by 23 percent, save the U.S. economy 1.2 trillion dollars, and reduce greenhouse gas emission by 1.1 gigatons annually. Therefore, the ability to understand and manage energy consumption is vital to reduce energy costs, help the environment, and achieve LEED certification.

### SUMMARY

One example embodiment includes a computer-readable medium that has computer-executable instructions stored thereon for performing an energy usage index method. The method includes monitoring an energy usage of a facility region. The method further includes calculating an energy intensity based, at least in part, on the energy usage of the facility region and an area of the facility region. Additionally, in one embodiment, the energy intensity may be stored and a baseline calculated statistically, based, at least in part, on the energy intensity. The method further includes displaying the energy intensity for the facility region and generating an alert if the energy intensity meets a threshold level.

In another example embodiment, an energy usage index system includes an energy intensity calculation logic, an energy intensity display logic, and an energy intensity alert logic. The energy intensity calculation logic calculates an energy intensity based, at least in part, on an energy usage of a facility region. The energy intensity display logic displays the energy intensity of the facility region. Furthermore, the energy intensity alert logic generates an alert if the energy intensity meets or exceeds a threshold level for the facility region.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example embodiment of a method associated with an energy usage index.

FIG. 2A illustrates an example embodiment of a system associated with an energy usage index.

FIG. 2B illustrates an example embodiment of a system associated with an energy usage index.

FIG. 3 illustrates an example computing environment in which example systems, methods, or equivalents may operate.

FIG. 4 illustrates an example embodiment of an energy usage index display screen.

FIG. 5 illustrates an example embodiment of an energy usage index display screen.

### DETAILED DESCRIPTION

Traditional methods of managing energy consumption include energy monitoring systems. Energy monitoring systems provide information about energy usage and demand to end users. One useful indicator of energy consumption for a facility region, such as a room, warehouse, building, or set of buildings is energy intensity. Energy intensity is typically defined as an amount of energy consumed per unit of service or activity.

An energy usage index provides energy intensity monitoring capability. This capability is accomplished by monitoring an energy usage of a facility region and calculating the energy intensity based, at least in part, on the energy usage and the area of the facility region. Real-time and historical energy intensity data can be displayed in a visual presentation so that a user is able to interpret and manage energy usage. The energy intensity data may correspond to a last day, a last week, a last month, and so on. By monitoring an area of the facility region over a period of time and storing the associated energy intensity data, a baseline energy intensity can be statistically derived. Additionally, a threshold level can be set and alarm notifications can be generated when the energy intensity meets the threshold level for a given facility region.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication”, as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to a medium that participates in directly or indirectly providing signals, instructions and/or data. A computer-readable medium may take forms, including, but not limited to, non-volatile media or volatile media. Non-volatile media may include, for example, optical or magnetic disks, and so on. Volatile media may include, for example, semiconductor memories, dynamic memory and the like. Common forms of a computer-readable medium include, but are not limited to, a floppy disk, a flexible disk, a hard disk, a magnetic tape, other magnetic medium, a CD-ROM, other optical medium, a RAM, a ROM, an EPROM, a FLASH-EPROM, or other memory chip or card, a memory stick, and other media from which a computer, a processor or other electronic device can read.

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software embodied as computer-executable instructions stored on a computer-readable medium and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. It is to be appreciated that blocks with a dashed line are optional. Blocks may also be combined or separated into multiple components. Furthermore, additional and/or alternative methodologies can employ additional, not illustrated blocks.

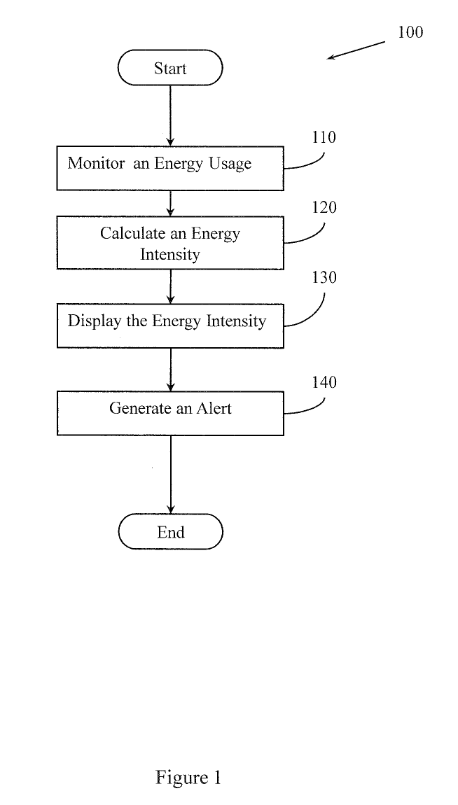

FIG. 1 illustrates an example embodiment of a method 100 associated with calculating and communicating an energy usage index. Method 100 includes, at 110, monitoring an energy usage of a facility region. The facility region may be, for example, a room, a floor, a building, a facility, multiple buildings, and so on. A user may input the area of the facility region being monitored or the area may be retrieved from another source, such as, for example, a database that stores area data for various facility regions. At 120, the method includes, calculating energy intensity based, at least in part, on the energy usage and the area of the facility region. The energy intensity represents an amount of energy consumed per square foot of area. While energy intensity is calculated on a real time basis, the energy intensity may be accumulated or averaged for a period of time such as a previous 24 hours or a previous month. Additionally, the energy intensity associated with the monitoring may be stored for further analysis or calculation. For example, in one example embodiment, a baseline energy intensity for a given area is calculated statistically, based, at least in part, on the energy intensity for the facility region for some predetermined prior period of time.

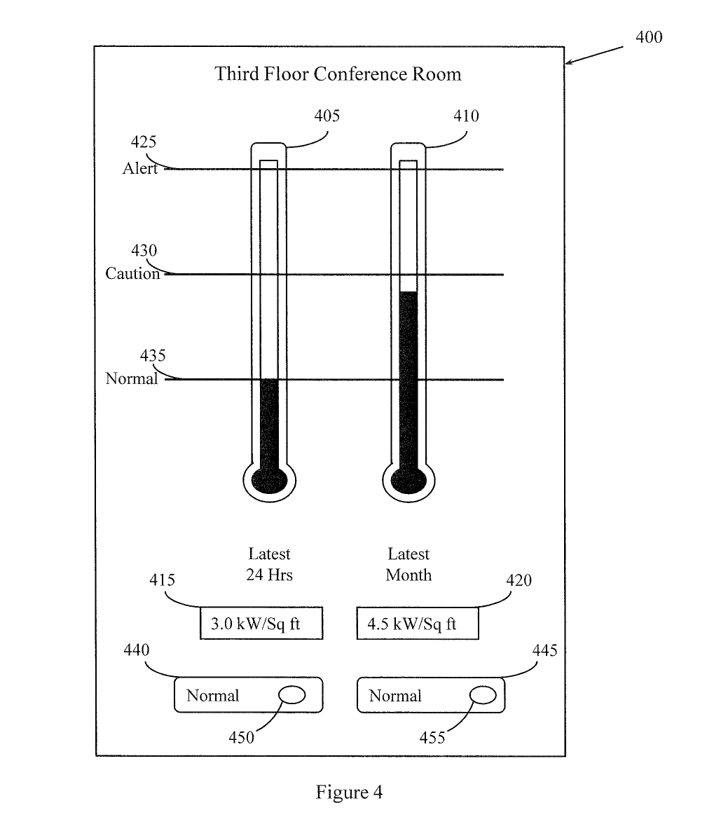

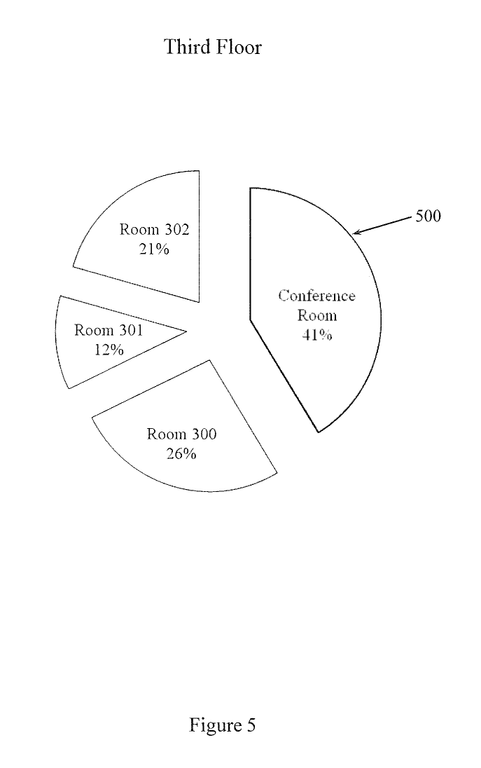

Method 100 also includes, at 130, displaying the energy intensity. The displaying may be performed on a computer display terminal or in printed form. In one example embodiment, the baseline energy intensity level, a current energy intensity level, an energy intensity caution threshold level, an energy intensity alert threshold level, and/or an energy intensity goal threshold level for a selected facility region are displayed. FIGS. 4 and 5 illustrate example embodiments of an energy intensity display.

At 140, the method includes generating an alert if the energy intensity meets an alert threshold level. The alert threshold level may be set by a user and/or automatically set based, at least on part, on a baseline or historical data. In addition to the alert threshold level, other thresholds that generate alerts may be established including the energy intensity caution threshold level, and the energy intensity goal threshold level. The alert may be generated by e-mailing the user, calling the user, or providing some other audible or visual alarm.

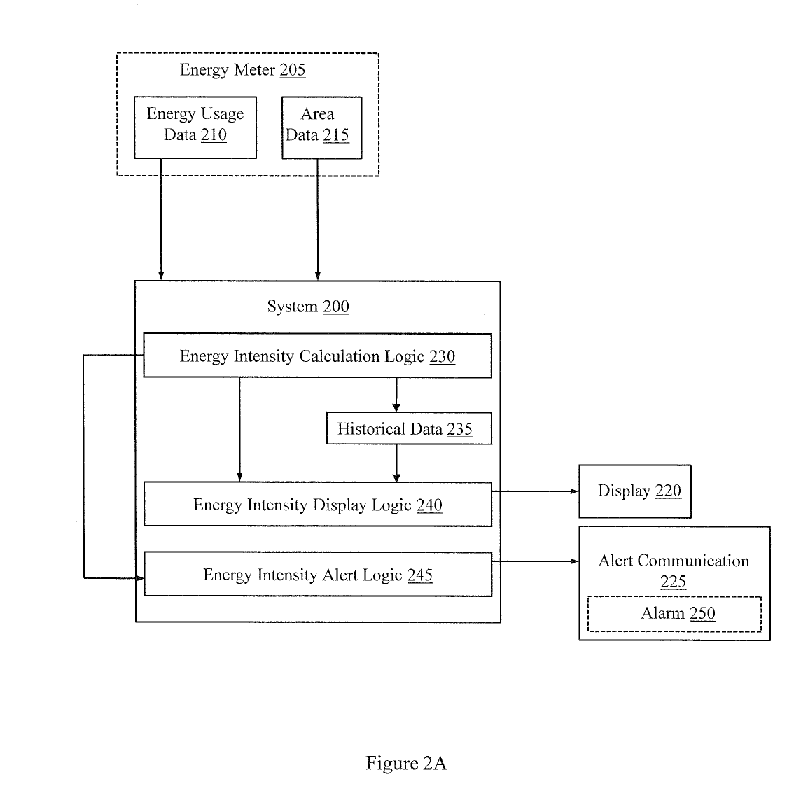

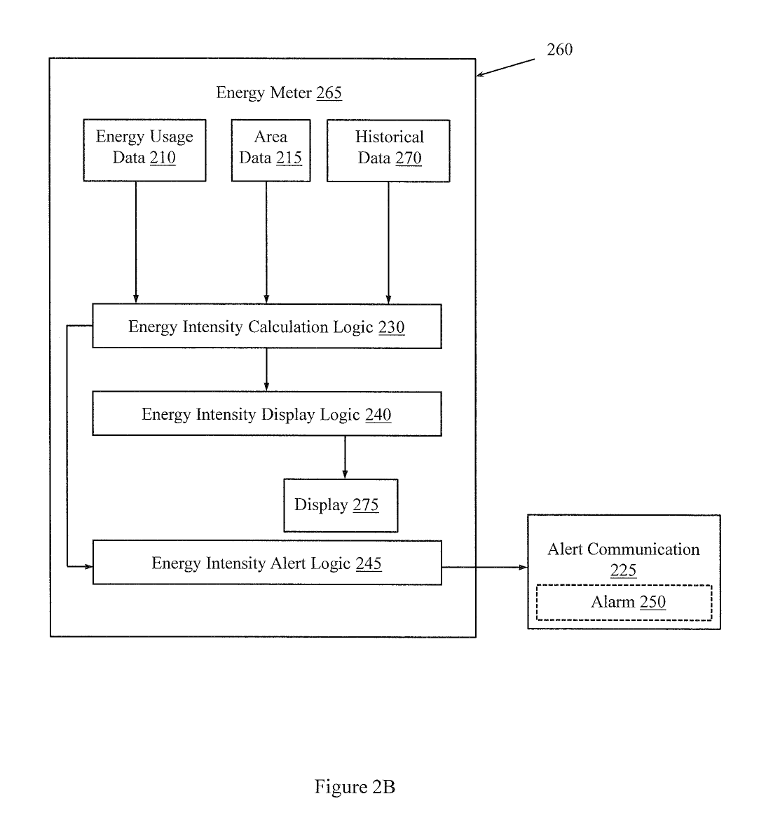

FIG. 2A illustrates an example embodiment of a system 200 associated with an energy usage index. The system 200 may be connected to energy meter 205. The energy meter 205 may monitor an energy usage in a facility region and store energy usage data 210 as well as area data 215. Accordingly, the system 200 may receive energy usage data 210 for a facility region and area data 215 for the facility region from energy meter 205. System 200 may display data, including energy usage data 210 and area data 215, associated with the facility region to a display 220 and generate an alert utilizing alert communication 225. The display 220 may be a personal computer or a web browser.

The system 200 includes energy intensity calculation logic 230. The energy intensity calculation logic 230 calculates an energy intensity for a facility region based, at least in part, on an energy usage of a facility region. The area of the facility region being monitored may be input by a user or retrieved from the energy meter 205 which stores area data 215. Additionally, the energy usage of a facility region can be retrieved from the energy meter 205. The energy usage of a facility region is used to determine the energy intensity for the facility region. The energy intensity is calculated based on the energy usage per square foot of area. The energy intensity calculation logic 230 may also statistically calculate a baseline energy intensity that is based, at least in part, on the energy intensity.

In one example embodiment, the energy intensity may be accumulated or averaged on a daily, weekly or monthly basis. This energy intensity data may be stored as historical data 235. The energy intensity calculation logic 230 may statistically calculate a baseline, a caution threshold level, or an alert threshold level based, at least in part, on historical data 235.

The system 200 also includes energy intensity display logic 240. The energy intensity display logic 240 displays a selected facility region as calculated by energy intensity calculation logic 230. The energy intensity display logic 230 displays the energy intensity of the facility region on the display 220. The historical data 235 may also be displayed on the display 220. Additionally, the energy intensity display logic 240, may display the baseline energy intensity, a current energy usage level, a caution threshold level, an alert threshold level, and/or a goal threshold level.

The energy intensity alert logic 245 generates an alert if the energy intensity calculated by energy intensity calculation logic 230 meets or exceeds an alert threshold level. The threshold level may be set by a user, generated automatically based on the baseline, or generated automatically based on historical data 235. Other threshold levels include the caution threshold level and a goal threshold level. The energy intensity alert logic 245 may generate an alert, when any or all of the thresholds are met, using alert communication 225 by e-mailing the user, calling the user, or by activating an alarm 250.

FIG. 2B illustrates an example embodiment of a system 260 associated with an energy usage index. The system 260 is similar to system 200, except the system 260 includes energy meter 265 and display 275. The energy meter 265 includes energy usage data 210, area data 215, and historical data 270. The energy meter 265 may monitor an energy usage in a facility region and store energy usage data 210, area data 215, and historical data 270. The historical data 270 may include energy usage data for the facility region accumulated or averaged on a daily, weekly or monthly basis.

Additionally, the energy meter 265 includes energy intensity calculation logic 230, energy intensity display logic 240, energy intensity alert logic 245, and display 275. The energy intensity calculation logic 230 calculates an energy intensity for a facility region based, at least in part, on an energy usage of a facility region. The energy usage of a facility region is used to determine the energy intensity for the facility region. The energy intensity is calculated based on the energy usage per square foot of area. The energy intensity calculation logic 230 may also statistically calculate a baseline energy intensity that is based, at least in part, on the energy intensity. Additionally, the energy intensity calculation logic 230 may statistically calculate a baseline, a caution threshold level, or an alert threshold level based, at least in part, on historical data 270.

The energy intensity display logic 240 displays a selected facility region as calculated by energy intensity calculation logic 230. The energy intensity display logic 240 displays the energy intensity of the facility region on the display 225. The historical data 270 may also be displayed on the display 225. Additionally, the energy intensity display logic 240, may display the baseline energy intensity, a current energy usage level, a caution threshold level, an alert threshold level, and/or a goal threshold level. The display 275 could be a view screen or readout that is part of the energy meter 265.

The energy intensity alert logic 245 generates an alert if the energy intensity calculated by energy intensity calculation logic 230 meets or exceeds an alert threshold level. The threshold level may be set by a user, generated automatically based on the baseline, or generated automatically based on historical data 270. Other threshold levels include the caution threshold level and a goal threshold level. The energy intensity alert logic 245 may generate an alert, when any or all of the thresholds are met, using alert communication 225 by e-mailing the user, calling the user, or by activating an alarm 250.

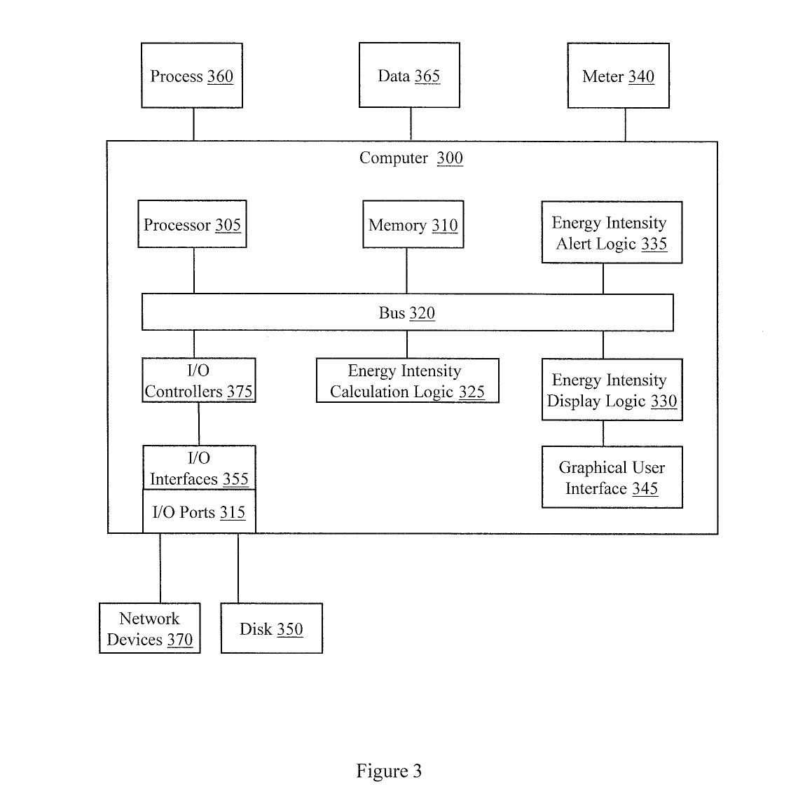

FIG. 3 illustrates an example computing environment in which example systems, methods, or equivalents may operate. The example computing device may be a computer 300. It is to be appreciated that the example computing environment may also be a meter. The computer 300 includes a processor 305, a memory 310, and input/output ports 315 operably connected by a bus 320. It is to be appreciated that computer 300 may also be a meter. In one example, the computer 300 may include an energy intensity calculation logic 325, an energy intensity display logic 330, and a energy intensity alert logic 335. In different examples, the energy intensity calculation logic 325, the energy intensity display logic 330, and the energy intensity alert logic 335 may be implemented in hardware, a method encoded as computer executable instructions on a computer-readable medium, firmware, and/or combinations thereof. While the energy intensity calculation logic 325, the energy intensity display logic 330, and the energy intensity alert logic 335 are illustrated as a hardware component attached to the bus 320, it is to be appreciated that in one example, these logics could be implemented in the processor 305.

The energy intensity calculation logic 325 may provide (e.g., hardware, firmware) means for determining an energy usage monitored by a meter 340. The means may be implemented, for example, as an ASIC programmed to receive data from the meter 340, electrical devices, and sensors.

The energy intensity display logic 330 may provide (e.g., hardware, firmware) means for displaying the energy intensity of the area utilizing a graphical user interface 345. The means may be implemented, for example, as an ASIC programmed to manipulate data received from electrical devices and sensors.

The energy intensity alert logic 335 may provide (e.g., hardware, firmware) means for generating an alert if the energy intensity meets a threshold level. The means may be implemented, for example, as an ASIC programmed to manipulate data received from electrical devices and sensors.

Generally describing an example configuration of the computer 300, the processor 305 may be a variety of various processors including dual microprocessor and other multi-processor architectures. A memory 310 may include volatile memory and/or non-volatile memory. Non-volatile memory may include, for example, ROM, programmable ROM (PROM), and so on. Volatile memory may include, for example, RAM, static RAM (SRAM), dynamic RAM (DRAM), and so on. While a computer 300 is described, energy intensity calculation logic 325, the energy intensity display logic 330, and the energy intensity alert logic 335 may appear in a networking device.

A disk 350 may be operably connected to the computer 300 via, for example, an input/output interface (e.g., card, device) 355 and an input/output port 315. The disk 350 may be, for example, a magnetic disk drive, a solid state disk drive, a floppy disk drive, a tape drive, a Zip drive, a flash memory card, a memory stick, and so on. Furthermore, the disk 350 may be a CD-ROM drive, a CD recordable (CD-R) drive, a CD rewriteable (CD-RW) drive, a digital versatile disk and/or digital video disk ROM (DVD ROM), and so on. The memory 310 can store a process 360 and/or data 365, for example. The disk 350 and/or the memory 310 can store an operating system that controls and allocates resources of the computer 300.

The bus 320 may be a single internal bus interconnect architecture and/or other bus or mesh architectures. While a single bus is illustrated, it is to be appreciated that the computer 300 may communicate with various devices, logics, and peripherals using other busses (e.g., peripheral component interconnect express (PCIE), 1394, universal serial bus (USB), Ethernet). The bus 320 can be types including, for example, a memory bus, a memory controller, a peripheral bus, an external bus, a crossbar switch, and/or a local bus.

The computer 300 may interact with input/output devices via the I/O interfaces 355 and the input/output ports 315. Input/output devices may be, for example, a keyboard, a microphone, a pointing and selection device, cameras, video cards, displays, the disk 350, the network devices 370, and so on. The input/output ports 315 may include, for example, serial ports, parallel ports, and USB ports.

The computer 300 can operate in a network environment and thus may be connected to the network devices 370 via the I/O interfaces 355, and/or the I/O ports 315. Through the network devices 370, the computer 300 may interact with a network. Through the network, the computer 300 may be logically connected to remote computers. Networks with which the computer 300 may interact include, but are not limited to, a LAN, a WAN, and other networks.

FIG. 4 illustrates an example embodiment of an energy usage index display 400 associated with a particular facility region, namely a “Third Floor Conference Room.” The energy usage index includes two thermometer-like gauges 405, 410. The black shaded area within gauges 405, 410 indicate the average energy intensity level for the past day and month, respectively. It is to be appreciated that the energy intensity may be presented in other various manners.

The gauge 405 indicates the average energy intensity from the latest 24 hours associated with the third floor conference room. Accordingly, the box 415 displays the value of the average energy intensity associated with gauge 405. The gauge 410 indicates the average energy intensity from the most recent month associated with the third floor conference room. The box 420 displays the value of the average energy intensity associated with gauge 410. It will be understood that the gauges 405, 410 may display the energy intensity for any number of different time intervals. For example, the displayed energy intensity can correspond to the last 24 hours, the last week, the last month, and so on.

The user may also set threshold levels using the display 400. The illustrated threshold levels are an energy intensity alert threshold level 425, an energy intensity caution threshold level 430, and an energy intensity normal threshold level 435. The normal threshold level 435 may also represent a baseline energy intensity. The baseline energy intensity is calculated statistically based, at least in part, on the historical energy intensity. In embodiment 400, gauges 405, 410 are both within the normal threshold. Thus the labels 415, 420 display “Normal” as the current operational status for both of the gauges 405, 410.

The labels 415, 420 may also include color indicators 450, 455. The color indicator 450 corresponds to the current status of energy intensity displayed on gauge 405 and the color indicator 455 corresponds to the status of energy intensity displayed on the gauge 410. In one embodiment, if the energy intensity meets or exceeds the alert threshold level 425 on the gauge 405, the color indicator 450 may turn red. In one other example embodiment, if the energy intensity meets or exceeds the caution threshold level 430 on the gauge 405, the color indicator 450 may turn yellow. In another example embodiment, if the energy intensity meets or exceeds the normal threshold level 430 on the gauge 405, the color indicator 450 may turn green.

FIG. 5 illustrates an example embodiment of an energy usage index display 500 associated with a particular facility region, namely the “Third Floor.” The energy usage index is displayed as a pie chart showing “tenant slices.” Each “tenant slice” is associated with a specific area within a particular facility region. For example, room 300, room 301, room 302, and conference room are each specific areas within the third floor. The “tenant slice” corresponds to the proportional amount of energy intensity of the third floor. For example, room 302 comprises 31% of the total energy intensity of the third floor. It is to be appreciated that the energy intensity may be presented in other various manners.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

What is claimed is:

1. A computer-readable medium having computer-executable instructions stored thereon for performing a method, the method comprising:
monitoring an energy usage of a facility region;
calculating an energy intensity for the facility region based, at least in part, on the energy usage of the facility region and an area of the facility region;
displaying the energy intensity; and
generating an alert if the energy intensity meets a threshold level.

2. The computer-readable medium of claim 1 where the energy intensity is calculated as an amount of energy consumed per square foot of the facility region.

3. The computer-readable medium of claim 1 where a user inputs the area of the facility region to be monitored.

4. The computer-readable medium of claim 1 where the method includes displaying an average energy intensity for a previous period of time.

5. The computer-readable medium of claim 1 where the method further comprises storing the energy intensity and calculating a baseline energy intensity based, at least in part, on the stored energy intensity.

6. The computer-readable medium of claim 1 where the method further comprises receiving a value for the threshold level from the user.

7. The computer-readable medium of claim 1 where the method comprises displaying a caution threshold level, an alert threshold level, and a goal threshold level.

8. The computer-readable medium of claim 1 where the method comprises displaying the baseline energy intensity and a current energy intensity.

9. The computer-readable medium of claim 1 where generating the alert is performed by e-mailing the user, calling the user, or activating an alarm.

10. A system, comprising:
an energy intensity calculation logic to calculate an energy intensity based, at least in part, on an energy usage of a facility region and an area of the facility region;
an energy intensity display logic to cause the energy intensity of the facility region to be displayed; and
an energy intensity alert logic to generate an alert if the energy intensity meets a threshold level.

11. The system of claim 10 further comprising a meter to monitor the energy usage of the facility region.

12. The system of claim 10 where the energy intensity is calculated by the energy intensity calculation logic as the energy usage per square foot of the facility region.

13. The system of claim 10 where the area of the facility region to be monitored is input by the user.

14. The system of claim 10 where the energy intensity calculation logic calculates an average energy intensity for a previous period of time.

15. The system of claim 10 where the energy intensity calculation logic stores historical energy intensity data and calculates a baseline energy intensity based, at least in part, on the historical energy intensity.

16. The system of claim 10 where the energy intensity calculation logic receives a value for the threshold level from the user.

17. The system of claim 10 where energy intensity display logic causes a caution threshold level, an alert threshold level, or a goal threshold level to be displayed.

18. The system of claim 10 where the system energy intensity display logic causes the baseline energy intensity and a current energy usage level to be displayed.

19. The system of claim 10 where the energy intensity alert logic generates the alert by e-mailing the user, calling the user, or activating an alarm.

20. A system, comprising:
means for monitoring an energy usage of a facility region;
means for calculating an energy intensity for the facility region based, at least in part, on the energy usage of the facility region and an area of the facility region;
means for displaying the energy intensity of the facility region; and
means for generating an alert if the energy intensity meets a threshold level.

21. The system of claim 20 where the means for calculating the energy intensity includes a means for calculating the energy intensity as the energy usage per square foot of the facility region.

22. The system of claim 20 where the means for calculating the energy intensity includes a means for storing historical energy intensity data and calculating a baseline energy intensity based, at least in part, on the historical energy intensity.

23. The system of claim 20 where the means for calculating the energy intensity includes a means for receiving a value for a threshold level from the user.

24. The system of claim 20 where the means for displaying includes a means to cause a caution threshold level, an alert threshold level, a goal threshold level to be displayed.

25. The system of claim 20 where the means for displaying includes a means to cause the baseline energy intensity and a current energy usage level to be displayed.

26. The system of claim 20 where the means for generating the alert includes a means for e-mailing the user, calling the user, or activating an alarm.
